(19) United States
(12) Patent Application Publication
(10) Pub. No.: US 2025/0333992 A1
(43) Pub. Date: Oct. 30, 2025

(54) CONTROL APPARATUS AND VEHICLE

(71) Applicant: TOYOTA JIDOSHA KABUSHIKI KAISHA, Toyota-shi Aichi-ken (JP)

(72) Inventors: Mitsuhiro MIURA, Toyota-shi Aichi-ken (JP); Yoshiaki TOMATSU, Toyoake-shi Aichi-ken (JP)

(73) Assignee: TOYOTA JIDOSHA KABUSHIKI KAISHA, Toyota-shi Aichi-ken (JP)

(21) Appl. No.: 19/185,460

(22) Filed: Apr. 22, 2025

(30) Foreign Application Priority Data
Apr. 25, 2024 (JP) 2024-071082

(51) Int. Cl. E05F 15/40

(52) U.S. Cl. CPC E05F 15/40; E05Y 2900/531

(57) ABSTRACT

If it is detected that a passenger is present in the predetermined area set near the door inside the vehicle while the door is in open state, the control apparatus prohibits door closing control. Further, the control apparatus executes the door closing control when first operation is performed by the driver while the door closing control is prohibited, the first operation being an operation in which a close button is pressed after a release switch is turned on. Further, the control apparatus executes the door closing control also when second operation is performed by the driver while the door closing control is prohibited under a state where the number of standing passengers in the vehicle is equal to or greater than a predetermined threshold, the second operation being an operation in which the close button is pressed twice in a row.

### CROSS REFERENCE TO THE RELATED APPLICATION

This application claims the benefit of Japanese Patent Application No. 2024-071082, filed on Apr. 25, 2024, which is hereby incorporated by reference herein in its entirety.

### BACKGROUND

### Technical Field

The present disclosure relates to door closing control of a vehicle on which a plurality of passengers are on board.

### Description of the Related Art

Patent Literature 1 discloses a monitoring system for remotely monitoring the cabin of multiple vehicle with passengers on board. In the monitoring system disclosed in Patent Document 1, images captured by cameras installed in each vehicle are displayed on a display device.

### CITATION LIST

### Patent Literature

Patent Literature 1: Japanese Patent Application Laid-Open Publication No. 2022-094724

### SUMMARY

The purpose of present disclosure is to provide a technology that can reduce the burden on the driver when operating a vehicle on which a plurality of passengers are on board.

A control apparatus according to the first aspect of the present disclosure may be a control apparatus that controls a door of a vehicle on which a plurality of passengers are on board, wherein
a predetermined area, where door closing control is prohibited if it is detected that a passenger is present in the area, is set near the door inside the vehicle,
a close button and a release switch, which are operated by the driver of the vehicle, are provided in the vehicle, the close button being a button that is pressed when a driver executes the door closing control, and the release switch being a switch that is turned on when the driver cancels the door closing control, and
the control apparatus having a controller configured to:
   prohibit the door closing control when it is detected that the passenger is present in the predetermined area while the door is in open state,
   execute the door closing control when first operation is performed by the driver while the door closing control is prohibited, the first operation being an operation in which the close button is pressed after the release switch is turned on, and
   execute the door closing control also when second operation is performed by the driver while the door closing control is prohibited under a state where the number of standing passengers in the vehicle is equal to or greater than a predetermined threshold, the second operation being an operation in which the close button is pressed twice in a row.

A vehicle according to the second aspect of the present disclosure may be a vehicle comprising the control apparatus according to the first aspect of the present disclosure.

According to the present disclosure, it is possible to reduce the burden on the driver when operating the vehicle on which a plurality of passengers are on board.

### BRIEF DESCRIPTION OF THE DRAWINGS

FIG. 1 is a diagram for explaining various devices mounted on a vehicle.

FIG. 2 is a diagram to explain state inside a vehicle.

FIG. 3 is a block diagram schematically showing the hardware configuration of a control apparatus mounted on a vehicle.

FIG. 4 is a first flowchart illustrating the flow of control executed by a controller while a door is in open state in a vehicle.

FIG. 5 is a diagram for explaining an operation of a driver when the prohibition on door closing control is canceled and the door closing control is executed in the vehicle.

FIG. 6 is a second flowchart illustrating the flow of control executed by a controller while a door is in open state in a vehicle.

### DESCRIPTION OF THE EMBODIMENTS

In a vehicle (for example, a route bus or a shared vehicle) in which a plurality of passengers are boarded, the door is opened and closed by the operation of the driver. Here, a close button operated by the driver may be provided on the vehicle. The close button is a button that is pressed by the driver when the driver causes the vehicle to perform the door closing control.

Further, if the door closing control is executed while a passenger is present near the door inside the vehicle, the passenger may be caught by the door. In order to prevent incidents where passengers get caught by the door of the vehicle, there might be a predetermined area set near the doors inside the vehicle. the predetermined area is set as an area where the door closing control is prohibited if it is detected that a passenger is present in the area. In a vehicle in which such a predetermined area is set, door closing control is prohibited when it is detected that a passenger is present in the predetermined area when the door is in open state. When door closing control is prohibited, even if the driver presses close button, it is usually door closing control is not executed.

However, even when there are a passenger present within the predetermined area inside the vehicle, it is possible to prevent passengers from being caught by the door when the door closing control is executed, by implementing a visual safety check by the driver or alerting the passengers, etc. And in view of the smooth operation of the vehicle on which a plurality of passengers are on board, even if there is the passenger in the predetermined area in the vehicle, in some embodiments, the prohibition of the door closing control is canceled by the operation of the driver. If the prohibition of the door closing control is canceled, it becomes possible to perform the door closing control even if there the passenger in the predetermined area.

The control apparatus according to the present disclosure is an apparatus that controls a door of a vehicle on which a plurality of passengers are on board. Further, a predetermined area is set near the door inside vehicle. In addition, the vehicle is provided with a release switch as well as a close button. the release switch is a switch operated by the driver of vehicle. A release switch is a switch that is turned on by the driver when the driver cancels the prohibition of door closing control.

In the control apparatus according to the present disclosure, when it is detected that there is a passenger in a predetermined area when the door is in open state, the controller prohibits the door closing control. In addition, when first operation is performed by the driver while the door closing control is prohibited (i.e., when there is a passenger in the predetermined area), the controller executes the door closing control. Here, the first operation is an operation in which the close button is pressed after the release switch is turned on. Thus, even if there is the passenger in a predetermined area, it is possible that the door closing control can be executed by executing the first operation.

However, the greater the number of standing passengers in the vehicle, the easier it is for passengers to enter the predetermined area. Therefore, if the number of standing passengers in vehicle increases, the door closing control is banned more often. If the door closing control is prohibited more frequently, it may become bothersome for the driver to perform the first operation to cancel the prohibition of the door closing control and execute the door closing control.

Therefore, in the control apparatus of the present disclosure, when the door closing control is prohibited under a state where the number of standing passengers in the vehicle is equal to or greater than the predetermined threshold, the controller performs door closing control not only when the first operation is performed by the driver, but also when the second operation is performed by the driver. Here, the second operation is an operation in which close button is pressed twice in a row. The second operation does not require the operation of a switch other than the close button as in the first operation. In other words, in the second operation, the driver only needs to operate the close button. Therefore, as an operation for canceling the prohibition of the door closing control and then executing the door closing control, the second operation is considered to be less bothersome to the driver than the first operation.

Further, when the number of standing passengers in the vehicle is equal to or greater than a predetermined threshold value, compared to when the number of standing passengers in the vehicle is less than a predetermined threshold value, a situation in which door closing control is prohibited due to passengers entering the predetermined area is likely to occur.

In other words, in order to continue the operation of the vehicle, the frequency with which the driver needs to cancel the prohibition of the door closing control is relatively high. According to the above, in such a situation where the frequency of occurrence of a state in which the door closing control is prohibited is relatively high, it is possible for the driver to execute the door closing control not only by the first operation but also by the second operation. Thus, it is possible to reduce the driver's bothersome when the driver frequently executes an operation to cancel the prohibition of the door closing control. As a result, it is possible to reduce the burden on the driver when operating the vehicle on which a plurality of passengers are on board.

Hereinafter, a specific embodiment of the present disclosure will be described with reference to the drawings. Dimensions, materials, shapes, relative positions and the like of structural components described in the present embodiment are not intended to limit the technical scope of the present disclosure unless stated otherwise.

### EMBODIMENT

### Schematic Configuration of Vehicle

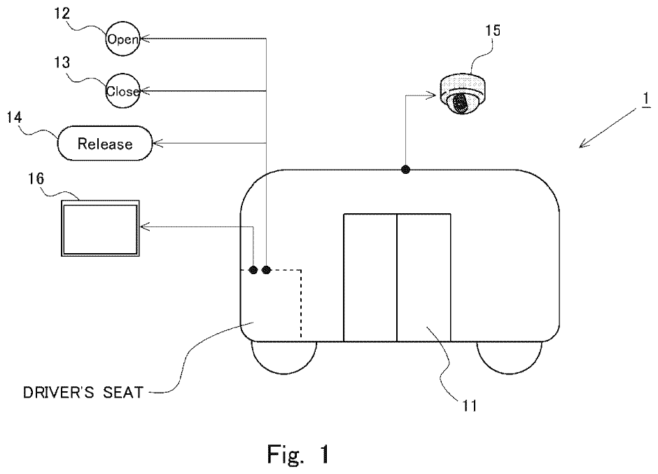

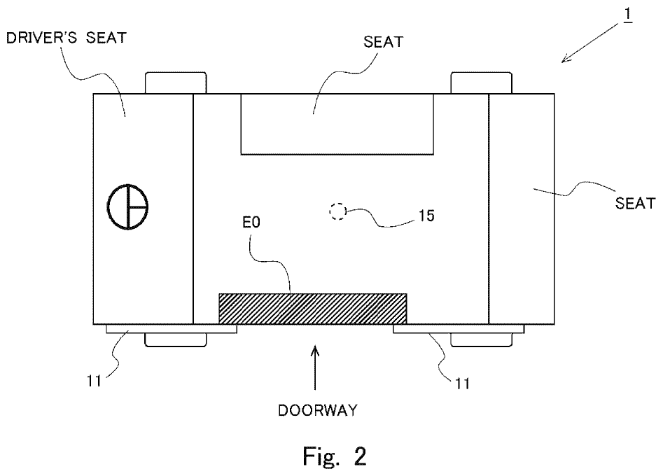

A schematic configuration of a vehicle according to the present embodiment will be described on the basis of FIGS. 1 and 2. FIG. 1 is a diagram for explaining various devices mounted on the vehicle. FIG. 2 is a diagram to explain the inside of the vehicle. A vehicle 1 is a vehicle on which a plurality of passengers are on board. For example, the vehicle 1 may be a route bus, a shared vehicle, or the like.

The vehicle 1 is a vehicle driven by the driver. The driver of the vehicle 1 executes various operations necessary for the operation of the vehicle 1 together with the operation of the vehicle 1 in the driver's seat of the vehicle. In addition, a seat is installed in the vehicle 1 for passengers to sit on. However, the vehicle 1 has a space in the vehicle in which there is a passenger who is not seated in the seat, that is, a passenger who gets on in a standing state (standing passenger).

A door 11 is provided on the side of the vehicle 1. The door 11 is a door for opening and closing the entrance and exit where passengers get on and off in the vehicle 1. When passengers get on and off the stopped vehicle 1, the door 11 is open. The door 11 is a sliding door that slides in the longitudinal direction of the vehicle 1 when opening and closing. In vehicle 1, the floor surface of the space used by passengers, including the vicinity of the door 11 in the vehicle, is formed substantially flat. Therefore, the passengers of vehicle 1 can easily move inside the vehicle 1. Note, the door of vehicle 1 does not necessarily have to be a sliding type. Further, it is not mandatory that the floor surface inside the vehicle 1 is flat.

An in-vehicle camera 15 is installed on the vehicle 1. The in-vehicle camera 15 can image approximately the entire space used by passengers inside the vehicle 1. Therefore, the in-vehicle camera 15 can capture an image including a passenger and a standing passenger seated in the seat. Further, the in-vehicle camera 15 can also image passengers getting on and off through the doorway of the vehicle 1. Further, a display 16 is disposed near the driver's seat of the vehicle 1. The display 16 displays an image captured by the in-vehicle camera 15. Therefore, the driver of the vehicle 1 can monitor the situation inside the vehicle 1 by the image displayed on the display 16. Basically, the display 16 displays a moving image of the inside of the vehicle 1 captured by the in-vehicle camera 15 in real time.

Further, an open button 12, a close button 13, and a release switch 14 are disposed in the driver's seat of the vehicle 1. In the vehicle 1, the opening/closing control of the door 11 is executed according to the operation of the open button 12 or the close button 13 by the driver. Specifically, when the open button 12 is pressed by the driver when the door 11 is in close state, the opening control of the door 11 is executed. Further, when the close button 13 is pressed by the driver when the door 11 is in open state, the closing control of the door 11 is executed. Further, in the vehicle 1, the closing control of the door 11 may be automatically prohibited as described later. In a state where the closing control of the door 11 is prohibited, basically, even if the close button 13 is pressed by the driver, the closing control of the door 11 is not executed. However, when the closing control of door 11 is prohibited, if the release switch 14 is turned ON by the driver, the prohibition of closing control of door 11 is canceled.

Here, the prohibition of closing control of the door 11 in the vehicle 1 and its cancellation will be described. If the closing control of the door 11 is executed while a passenger is present near the door 11 in the vehicle 1, there is a possibility that the passenger is caught by the door 11. In particular, as described above, the door 11 in the vehicle 1 is a sliding door, and the floor surface is substantially flat in the vehicle, including the vicinity of the door 11. Therefore, it is easy for passengers to approach the door 11 in the vehicle 1. Therefore, a situation in which a passenger may be caught by the door 11 when the closing control of the door 11 is executed is likely to occur.

Therefore, as indicated in FIG. 2, in the interior of the vehicle 1, the prohibited area E0 is set near the door 11. The prohibited area E0 is set as an area where the closing control of the door 11 is prohibited when the presence of a passenger is detected inside. Note that whether or not there is a passenger in the prohibited area E0 can be determined based on the image captured by the in-vehicle camera 15. Then, if it is detected that there is a passenger in the prohibited area E0 when the door 11 is in open state, the closing control of the door 11 is prohibited.

Here, as described above, when the closing control of the door 11 is prohibited due to the presence of a passenger in the prohibited area E0, the driver can confirm the situation near the door 11 in the vehicle by the image displayed on the display 16 or by visual inspection. Further, even if there is a passenger in the prohibited area E0, the driver can alert the passenger by announcing in advance in the vehicle that the closing control of the door 11 will be executed. Then, if the driver determines that the closing control of door 11 can be executed while ensuring the safety of the passenger even in the presence of passengers in the prohibited area E0, the driver will perform the release switch 14. As a result, the prohibition of closing control of door 11 is canceled, and the driver subsequently presses the close button 13 to closing control is executed. In the following, the operation of pressing the close button 13 after the release switch 14 is turned ON may sometimes be referred to as the “first operation.” In the vehicle 1, even if there is a passenger in the prohibited area E0, the closing control of the door 11 can be executed by executing the first operation by the driver.

Here, if all passengers present in the vehicle 1 are seated, the passenger does not enter the prohibited area E0. However, if there is a passenger standing in the vehicle 1, the passenger may enter the prohibited area E0. And the larger the number of standing passengers in the vehicle 1, the easier it is for passengers to enter the prohibited area E0. Therefore, the greater the number of standing passengers in vehicle 1, the closing control of door 11 may be prohibited more frequently.

Even if the frequency with which the door 11 closing control is prohibited increases, the door closing control can be executed by executing the first operation by the driver. However, as described above, in the first operation, a release switch 14, different from the close button 13, needs to be operated by the driver. Therefore, if the frequency of closing control of the door being prohibited increases, there may be a risk that it becomes bothersome for the driver to perform the first operation to cancel the prohibition on closing control of the door and execute the closing control of the door.

Therefore, in the vehicle 1 according to the present embodiment, when the number of standing passengers in the vehicle 1 is equal to or greater than a predetermined threshold value, a second operation is set as an operation for canceling the prohibition on closing control of the door 11 and executing closing control of the door 11. The second operation is an operation in which the close button 13 is pressed twice in a row. As a result, when the number of standing passengers in the vehicle 1 is equal to or greater than a predetermined threshold value, in a state where the closing control of the door 11 is prohibited, not only when the first operation is performed by the driver but also when the second operation is performed by the driver, the prohibition on closing control of door 11 is canceled and the closing control of door 11 is executed.

### Hardware Configuration of Control Apparatus

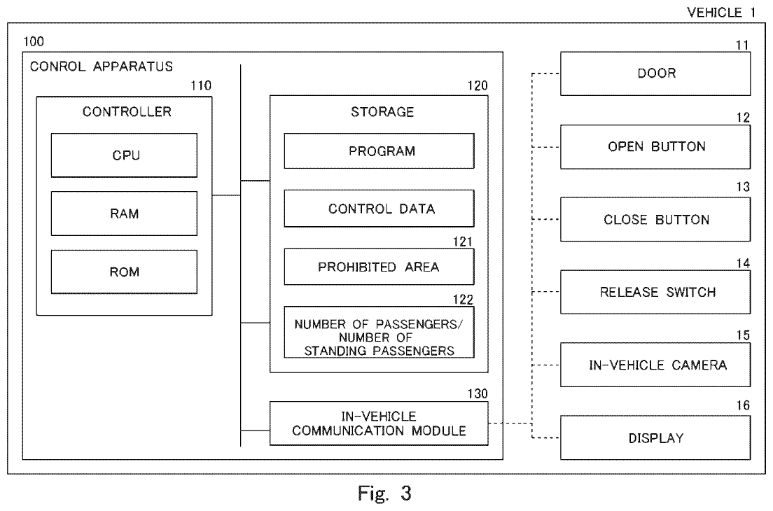

Next, a control apparatus mounted on vehicle 1 will be described based on FIG. 3. FIG. 3 is a schematic hardware configuration of the control apparatus mounted on the block FIG. 3. The control apparatus 100 is an apparatus that controls the opening and closing of the door of the vehicle 1. In the vehicle 1, the control apparatus 100 is connected to the door 11, the open button 12, the close button 13, the release switch 14, the in-vehicle camera 15, and the display 16.

The control apparatus 100 includes a controller 110, a storage 120, and an in-vehicle communication module 130. The controller 110 has a function of performing an arithmetic process for controlling the control apparatus 100. The controller 110 includes a processor such as a CPU (Central Processing Unit), a main storage device such as RAM (Random Access Memory), and an auxiliary storage device such as ROM (Read Only Memory). Note that CPU is an example of processor resources. RAM and ROM are examples of memory resources. The controller 110 can execute arbitrary information processing based on various programs and various data. However, some or all of the functions of the controller 110 may be realized by a hardware circuit such as an ASIC or an FPGA.

The storage 120 is configured by any storage device such as RAM, ROM, hard disk drive, flash memory, etc. The storage 120 may also include removable media (portable recording media). Here, the removable media is, for example, a USB memory, an SD card, or a disc recording medium such as a CD-ROM, DVD disc, or Blu-ray disc. The storage 120 stores a program executed by the controller 110 and control data used for executing the program.

Further, the storage 120 stores data 121 indicating the position and range of the prohibited area E0 set in the vehicle 1. Further, in the control apparatus 100, the controller 110 counts the number of passengers and the number of standing passengers in the vehicle based on the image captured by the in-vehicle camera 15. Then, the number of counted passengers and the number of standing passengers 122 are stored in the storage 120.

The in-vehicle communication module 130 is an interface for the control apparatus 100 to communicate with other devices provided in the vehicle 1 using a predetermined in-vehicle communication standard. Examples of the predetermined in-vehicle communication standard include CAN (Controller Area Network) or LIN (Local Interconnect Network) and the like. The control apparatus 100 communicates with various devices provided in the vehicle 1 via the in-vehicle communication module 130.

In the control apparatus 100, the controller 110 executes opening control of the door 11 when it receives an indicate signal that the open button 12 has been pressed. Further, when the controller 110 receives an indicate signal that the close button 13 has been pressed, the controller 110 executes a closing control of the door 11. Further, the controller 110 acquires an image captured by the in-vehicle camera 15 via the in-vehicle communication module 130. Further, the controller 110 indicates the image captured by the in-vehicle camera 15 on the display 16.

Further, the controller 110 determines whether or not there is a standing passenger in the prohibited area E0 in the vehicle 1 based on the image acquired from the in-vehicle camera 15. Furthermore, the controller 110 prohibits the closing control of the door 11 when it detects the presence of a standing passenger in the prohibited area E0 inside the vehicle. In a state where the closing control of the door 11 is prohibited, the controller 110 does not execute the closing control of the door 11 even when a signal indicating that the close button 13 is pressed is received. Further, when the controller 110 receives an indicate signal that the release switch 14 has been turned on when the closing control of the door 11 is prohibited, the controller 110 cancels the prohibition of the closing control of the door 11. Further, when the controller 110 detects that a standing passenger existing in the prohibited area E0 has moved from the prohibited area E0 based on the image acquired from the in-vehicle camera 15, the controller 110 cancels the prohibition of the closing control of the door 11.

In the present embodiment, the control apparatus 100 does not necessarily have to be realized by a single physical configuration, but may be configured by a plurality of computers provided on the vehicle 1 and linked with each other.

### Control Flow

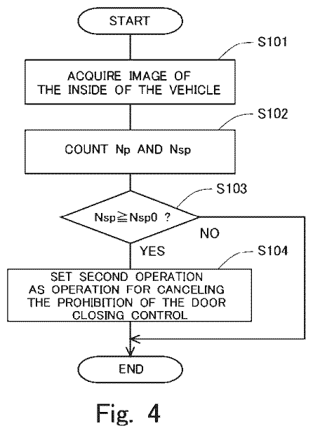

Next, the control executed by the control apparatus 100 when the vehicle 1 is stopped and the door 11 is in the open state will be described based on FIG. 4. FIG. 4 is a flowchart showing the flow of control executed by the controller 110 when the door 11 is open in the vehicle. When the door 11 is in open state in the vehicle 1, the controller 110 may repeatedly execute the control flow shown in FIG. 4 at predetermined intervals.

In this flow, first, an image of the inside of the vehicle captured by the in-vehicle camera 15 is acquired in S101. Next, in S102, the number of passengers Np and the number of standing passengers Nsp present in the vehicle 1 are counted based on the image of the inside of the vehicle acquired in S101. Specifically, the controller 110 extracts passengers from the image inside the vehicle and counts the number of passengers Np. Further, the controller 110 extracts passengers who are not seated in the seat from the image inside the vehicle, and counts the number of standing passengers. The controller 110 stores the number of passengers Np and the number of standing passengers Nsp counted in S102 in the storage 120.

When the door 11 of the vehicle 1 is in an open state, a passenger may get on or off from the entrance or exit of the vehicle 1. Therefore, when a passenger gets on or off from the entrance of the vehicle 1, the controller 110 updates the number of passengers Np and the number of standing passengers Nsp. Further, the controller 110 may display the number of passengers Np and the number of standing passengers Nsp counted in S102 on the display 16. The number of passengers Np and the number of standing passengers Nsp are displayed on the display 16 so that the driver can grasp these numbers.

Next, in S103, it is determined whether or not the number of standing passengers Nsp counted in S102 is equal to or greater than a predetermined threshold value Nsp0. If it is negatively determined in S103, that is, when the number of passengers Nsp is less than the predetermined threshold value Nsp0, the execution of this flow is temporarily terminated. On the other hand, when a positive determination is made in S103, the process of S104 is then executed. In S104, a second operation is set as an operation for canceling the prohibition of the closing control of the door 11 and executing the closing control of the door 11.

By executing the above control flow, when the number of standing passengers Nsp in the vehicle 1 is equal to or greater than the predetermined threshold value Nsp0, the prohibition of the closing control of door 11 can be canceled by executing the second operation by the driver, making it possible for the closing control of the door 11 to be executed.

### Canceling of the Prohibition of Door Closing Control

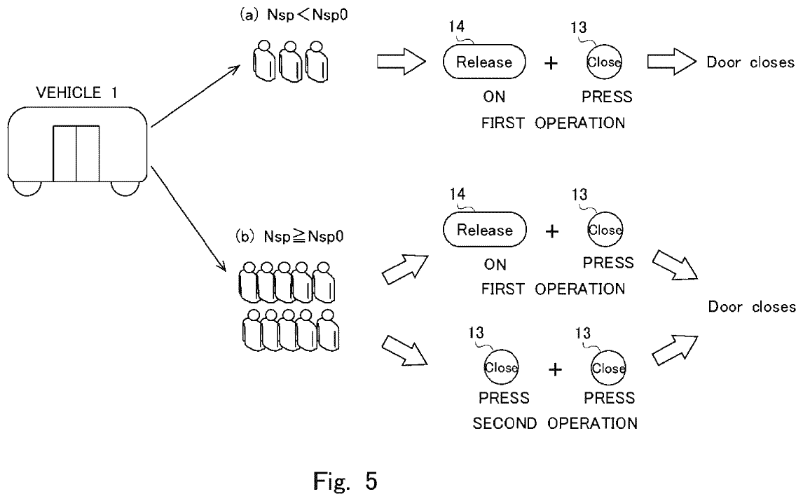

As described above, depending on whether the number Nsp of standing passengers in the vehicle 1 is greater than or equal to a predetermined threshold Nsp0, the driver's operation that enables the prohibition on the closing control of door 11 to be canceled and the closing control of door 11 to be executed is changed. FIG. 5 is a figure used to explain the driver's operations when the restriction on the closing control of door 11 is canceled and the closing control of door 11 is executed in the vehicle 1. All of the driver operations shown in FIG. 5 are operations performed by the driver when the controller 110 prohibits the closing control of the door 11 because the presence of passengers in the prohibited area E0 in the vehicle 1 is detected.

As shown in (a) of FIG. 5, when the number of standing passengers Nsp in the vehicle 1 is less than a predetermined threshold value Nsp0, the closing control of the door 11 is executed when the first operation is performed by the driver. Specifically, when the first operation is executed by the driver, the control apparatus 100 first receives a signal indicating that the release switch 14 has been turned on, and then receives a signal indicating that the close button 13 has been pressed. Thereby, the controller 110 cancels the prohibition of the closing control of the door 11 and executes the closing control of the door 11. However, when the number of standing passengers Ns in vehicle 1 is below the predetermined threshold Nsp0, the closing control of the door 11 is executed only when the first operation is performed by the driver. Therefore, when the number of standing passengers Nsp in the vehicle 1 is less than the predetermined threshold value Nsp0, the closing control of the door 11 is not executed even if the second operation is performed by the driver. In other words, even if the control apparatus 100 receives a signal indicating that the close button 13 has been pressed twice consecutively, it will not execute closing control of the door 11.

On the other hand, as shown in (b) of FIG. 5, when the number Nsp of standing passengers in vehicle 1 is equal to or greater than a predetermined threshold value Nsp0, closing control of door 11 is executed not only when the first operation is performed by the driver, but also when the second operation is performed by the driver. Specifically, when the second operation is performed by the driver, the control apparatus 100 receives a signal indicating that the close button 13 has been pressed twice in a row. Thereby, even if the controller 110 does not receive a signal indicating that the release switch 14 has been turned on, the prohibition of closing control of the door 11 is canceled and the closing control of the door 11 is executed.

In the second operation, it is not necessary to operate the release switch 14, which is different from the close button 13 used in the first operation. That is, in the second operation, the driver only needs to operate the close button 13. Therefore, as an operation to execute the closing control of the door 11 after canceling the prohibition of the closing control of the door 11, the second operation is considered to be less bothersome to the driver than the first operation.

As described above, when the number Nsp of standee passengers in vehicle 1 is equal to or greater than the predetermined threshold Nsp0, the frequency with which the driver needs to cancel the prohibition of the closing control of door 11 may relatively increase. According to the control according to the present embodiment, in such a situation where the frequency of occurrence of a state in which the closing control of the door 11 is prohibited is relatively high, not only the first operation but also the second operation It is possible for the driver to execute the door closing control. This can reduce the bothersome for the driver when frequently performing the operation to cancel the prohibition of closing control of door 11. As a result, the burden on the driver can be reduced when operating the vehicle 1 in which a plurality of passengers are boarded.

In the present embodiment, the controller 110 of the control apparatus 100 may adjust the closing speed of the door 11 in the closing control of the door 11. Specifically, when the controller 110 executes the closing control of the door 11 by pressing the close button 13 by the driver while no passengers is present in the prohibited area E0 in the vehicle 1, the controller 110 may set the closing speed of the door 11 to the standard speed. Then, when the controller 110 executes the closing control of the door 11 by performing the first operation or the second operation by the driver, the controller 110 may set the closing speed of the door 11 to a speed smaller than the standard speed.

According to this, when the closing control of the door 11 is executed because the driver performs the first or second operation when the closing control of the door 11 is prohibited, the closing speed of the door 11 is slower than when the closing control of the door 11 is executed when there is no passenger within the prohibited area E0. Therefore, even if the closing control of the door 11 is executed while there are passengers in the prohibited area E0, the occurrence of passenger being pinched by the door 11 can be further suppressed.

### Modification

Next, a modification of the present embodiment will be described. As described above, a prohibited area E0 is set in the vehicle 1. If the prohibited area E0 is set to a certain range, the greater the number of standing passengers in the vehicle 1, the easier it is for passengers to enter the prohibited area E0. Therefore, when the number of standing passengers in the vehicle 1 is equal to or greater than the predetermined threshold value, the closing control of the door 11 may be prohibited more frequently than when the number of standing passengers in the vehicle 1 is less than the predetermined threshold.

However, if the prohibited area E0 becomes narrow, it becomes difficult for passengers to enter the prohibited area E0. Therefore, in the present modification, the controller 110 of the control apparatus 100 variably controls the range of the prohibited area E0 set in the interior of the vehicle 1. Specifically, when the number of standing passengers in the vehicle 1 is less than a predetermined threshold, the controller 110 sets the prohibited area E0 in the standard range. On the other hand, when the number of standing passengers prohibited set area E0 to a range smaller than the standard range.

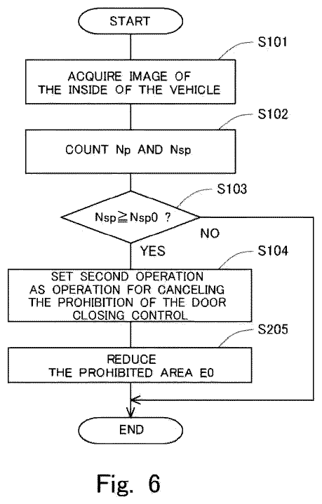

Hereinafter, in this modification, the control executed by the control apparatus 100 when the vehicle 1 is stopped and the door 11 is in the open state will be described based on FIG. 6. FIG. 6 is a flowchart showing the flow of control executed by the controller 110 when the door 11 is i open state in the vehicle 1. Note that the processes executed in S101 to S104 in the indicate flow shown in FIG. 6 are the same as those executed in the steps of the same reference number in the indicate flow in FIG. 4, respectively. Therefore, these steps are omitted.

In this flow, the process in S205 is executed next to S104. In S205, the prohibited area E0 is set to a range smaller than the standard range. At this time, the controller 110 may set the prohibited area E0 to a certain range reduced from the standard range. Further, the controller 110 may set the prohibited area E0 to a range corresponding to the number of standing passengers Nsp in the vehicle 1. That is, the controller 110 may set the prohibition area E0 to a smaller range as the number of standing passengers Nsp in the vehicle 1 increases. The data that indicates the position and range of the prohibited area E0 set in S205 is stored in the storage 120.

According to the above flow, when the number of standing passengers Nsp in the vehicle 1 is equal to or greater than the predetermined threshold value Nsp0, the prohibited area E0 is reduced compared to the case where the number of standing passengers Nsp in the vehicle 1 is less than the predetermined threshold value Nsp0. By reducing the prohibited area E0, it becomes more difficult for passengers to enter the prohibited area E0 than when the prohibited area E0 remains in the standard range. Therefore, even if the number of standing passengers Nsp in the vehicle 1 is equal to or greater than a predetermined threshold Nsp0, it is possible to suppress the frequency of the closing control of the door 11 being prohibited. As a result, the frequency with which the driver performs an operation to remove the prohibition of the closing control of the door 11 can be suppressed. Thereby, the burden on the driver can be further reduced during the operation of the vehicle 1 in which a plurality of passengers are boarded.

### Other Embodiments

The embodiments described above are merely examples, and the present disclosure may be changed and implemented as appropriate within the scope of the disclosure. Furthermore, processes and elements described in the present disclosure may be freely combined to the extent that no technical conflict exists.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), and any type of medium suitable for storing electronic instructions, such as read-only memories (ROMs), random access memories (RAMs), EPROMS, EEPROMs, magnetic cards, flash memories, or optical cards.

What is claimed is:

1. A control apparatus that controls a door of a vehicle on which a plurality of passengers are on board, wherein
a predetermined area, where door closing control is prohibited when it is detected that a passenger is present in the area, is set near the door inside the vehicle,
a close button and a release switch, which are operated by a driver of the vehicle, are provided in the vehicle, the close button being a button that is pressed when a driver executes the door closing control, and the release switch being a switch that is turned on when the driver cancels the door closing control, and
the control apparatus having a controller configured to:
prohibit the door closing control when it is detected that the passenger is present in the predetermined area while the door is in open state,
execute the door closing control when first operation is performed by the driver while the door closing control is prohibited, the first operation being an operation in which the close button is pressed after the release switch is turned on, and
execute the door closing control also when second operation is performed by the driver while the door closing control is prohibited under a state where the number of standing passengers in the vehicle is equal to or greater than a predetermined threshold, the second operation being an operation in which the close button is pressed twice in a row.

2. The control apparatus according to claim 1, wherein when the number of standing passengers in the vehicle is equal to or greater than the predetermined threshold, the controller reduces the predetermined area in the vehicle compared to when the number of standing passengers in the vehicle is less than the predetermined threshold.

3. The control apparatus according to claim 1, wherein when the controller executes the door closing control because the first operation or the second operation is performed by the driver while the door closing control is prohibited, the controller sets a closing speed of the door to be smaller than when the controller executes the door closing control while no passenger is present in the predetermined area.

4. The control apparatus according to claim 1, wherein, in the vehicle, a floor surface inside the vehicle including the predetermined area is substantially flat, and
the door is a sliding door.

5. A vehicle comprising the control apparatus according to claim 1.

6. A vehicle comprising the control apparatus according to claim 2.

7. A vehicle comprising the control apparatus according to claim 3.

8. A vehicle comprising the control apparatus according to claim 4.
